(19) United States
(12) Patent Application Publication
(10) Pub. No.: US 2019/0003667 A1
(43) Pub. Date: Jan. 3, 2019

(54) BLUETOOTH POWERPACK FOR WIRELESS LED STRING LIGHTS

(71) Applicant: Mart Marasco, Birmingham, AL (US)

(72) Inventor: Mart Marasco, Birmingham, AL (US)

(21) Appl. No.: 16/046,932

(22) Filed: Jul. 26, 2018

Related U.S. Application Data
(60) Provisional application No. 62/511,842, filed on May 26, 2017.

(51) Int. Cl. F21S 9/02; H05B 37/02; F21V 23/02; F21V 23/06; F21V 23/00

(52) U.S. Cl. CPC F21S 9/02; H05B 37/0272; F21Y 2115/10; F21V 23/06; F21V 23/001; F21V 23/023

(57) ABSTRACT

A bluetooth powerpack for wireless LED string lights including a light assembly, an LED light strand, and a power pack including a battery, and a housing. The LED light strand and power pack are in wireless communication with a mobile application hosted on a mobile device. The power pack is connected to and configured to provide power to lights configured on the LED light strand. The LED light strand is controlled via the mobile application. The power pack provides a portable power source for the LED light strand. The housing houses the battery. The device may be integrating in a garment to provide illuminate garments.

### CROSS REFERENCE TO RELATED APPLICATION

The present application is related to and claims priority to U.S. Provisional Patent Application No. 62/511,842 filed May 26, 2017, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of lighting and more specifically relates to string lights, their powering means and method of controlling.

### 2. Description of Related Art

LED string lights are used for a variety of applications, however there are restrictions due to method of power and control. An application such as incorporating LED string lights into clothing is possible, but currently has restrictions related to the method of power and control of the lighting incorporated into the clothing remotely. In order to utilize a light strand in clothing or another application a traditional power plug or battery pack is required. These options are limited in their abilities and do not enable users to control the lights remotely. A suitable solution is desired.

U.S. Pat. No. 5,149,190 to Robert MacKenzie relates to a portable safety device. The described portable safety device includes a means for attracting visual attention, which comprises an array of flashing light sources, comprising high intensity light-emitting diodes having a light output of at least 500 mcandela. The light sources are connected in series with a solid state flashing circuit and a power supply. The power supply comprises a high energy battery and current limiting means in series therewith. The current limiting means prevents the current supplied by the battery externally of the power supply from exceeding a predetermined safe value. The solid state flashing circuit is periodically switchable between a low resistance state characterized in that the voltage across the series arrangement of high intensity light-emitting diodes exceeds a threshold voltage thereof, and a high resistance state characterized in that the voltage across the series arrangement of high intensity light-emitting diodes falls below the threshold voltage. The high intensity light-emitting diodes flash brightly to provide a low current attention-attracting device visible at lone range.

### BRIEF SUMMARY OF THE INVENTION

In view of the foregoing disadvantages inherent in the known lighting art, the present disclosure provides a novel bluetooth enabled powerpack for wireless LED string light system for on the go rechargeable power and remote connectivity/control. The general purpose of the present disclosure, which will be described subsequently in greater detail, is to provide power to a wireless LED light string and functional control through a smart device utilizing integrated Bluetooth® technology. This invention can be incorporated into the many applications in which standard LED string lights are used.

The bluetooth powerpack for wireless LED string lights (“Bluetooth Low Energy (BLE) enabled power pack for wireless LED string lights”) is fully disclosed herein. The power pack is the power and control device of the entire system. The power pack incorporates a designed PCB with Bluetooth Low Energy (BLE) module, transistors, inductor connector, microcontroller, micro USB connector and a battery management control with a connected rechargeable lithium battery. This designed functionality in the power pack 1) allows for the wireless LED string lights to connect to the power pack via a magnetic transistor connector, 2) power the LED string lights 3) connect to a smart device wirelessly via Bluetooth connectivity 4) communicate controls of the LED string lights for functionality such as on/off, LED brightness, LED twinkling effect, twinkling speed, and LED color coordination and 5) Recharge the Lithium Battery by a connecting mini USB port to USB plug.

The LED string lights incorporate individual LED lights on a string with a magnetic connector with incorporated conductors on one end of the light string. The magnetic connector ensures a secure connection between the conductors integrated into the magnetic connector on the light strand and the integrated conductors on the magnetic connector on the power pack to provide power and connectivity to the LED string lights wirelessly. The LED string light when connected to the power pack is then controlled through a mobile application that connects and communicates directly to the bluetooth enabled power pack. The LED string light through the magnetic conducting connector pulls its power from the rechargeable lithium battery incorporated into the physically connected power pack. The LED string lights can be arranged in varies configurations from length, number of LED's and string configuration based on application. As an example, the LED string light is configured to be integrated into a garment to provide illumination. The garment may include children's' costume garments, such as skirts, dresses, crowns, and bed canopies. The physically connected power pack to the LED string light incorporated into the garment can be easily removed from the string lights and garment for a battery recharge or swop out with another power pack. This allows the lighting integrated into the garment to stay in place and flexibility of use and function anywhere with no restrictions.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present

The various embodiments of the present invention will hereinafter be described in disclosure, a bluetooth powerpack for wireless LED string lights, constructed and operative according to the teachings of the present disclosure.

FIG. 1 is a perspective view of the bluetooth powerpack for wireless LED string lights configuration sewn into a garment such as a child's costume dress during an ‘in-use’ condition, according to an embodiment of the disclosure.

FIG. 2 is a perspective view of the bluetooth powerpack for wireless LED string lights configuration with an end magnetic connector with power conductor/communication strips for physical connection to the previously described power pack, according to an embodiment of the disclosure.

FIG. 3 is a perspective view of the bluetooth powerpack for wireless LED string lights and how each piece from the LED light strand configuration, the power pack and a smart device connects with each other and functions with each other, according to an embodiment of the disclosure.

FIG. 4 is a perspective view of the bluetooth powerpack for wireless LED string lights including the power pack used as the central means of power and connectivity of the LED string light configuration and the smart device, according to an embodiment of the disclosure.

FIG. 5 is a perspective view of the LED light strand configuration prior to physical connection into the power pack which requires a mini USB/USB cord for battery recharge, according to an embodiment of the disclosure.

The various embodiments of the present invention will hereinafter be described in conjunction with the appended drawings, wherein like designations denote like elements.

### DETAILED DESCRIPTION

As discussed above, embodiments of the present disclosure relate to a lighting means and more particularly to a Bluetooth enabled powerpack for wireless LED string light system as used to improve the use of string lights and powering means for providing illumination integrated clothing and other items.

Generally, the present invention provides a method to create a wireless LED light strand with remote control via Bluetooth® technology. The designed powerpack within the system connects to any mobile device wirelessly and is controlled via a mobile application. Those skilled in the art will readily understand Bluetooth technology as used herein. This enables users to control the on/off status and light sequence using the app. It offers a mini LED light strand that can be sewn into custom children's costumes. The present invention encourages a child's imagination and experience by providing illuminated garments. The bluetooth powerpack for wireless LED string lights provides a mini LED light strand that communicates wirelessly via Bluetooth technology with a synced mobile device and application. The wireless LED light strand and power pack may be used as a wireless light source in a plurality of circumstances for illumination and decorative use.

The invention is comprised of a power pack made from a hard, plastic housing which ties each of the LED lights within the light strand together through the integrated connectivity prongs and is utilized as the connection point between the bluetooth powerpack for wireless LED string lights. The connector is a smaller hard plastic housing which ties each of the LED lights within the light strand together through the integrated connectivity prongs and is utilized as the connection point between the LED light strand and the bluetooth powerpack for wireless LED string lights can be recharged via a mini USB connector and USB connector cable that plugs into a USB outlet or outlet plug. The light strand and integrated connecter and latched power pack are integrated and sewn into children's costume garments, such as skirts, dresses, crowns, and bed canopies. The exact specifications may vary.

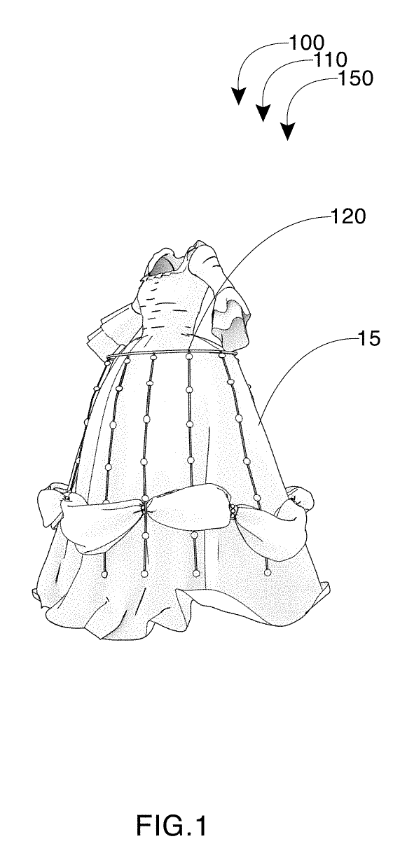

Referring now more specifically to the drawings by numerals of reference, there is shown in FIGS. 1-5, various views of a bluetooth powerpack for wireless LED string lights 100. FIG. 1 shows a bluetooth powerpack for wireless LED string lights 100 during an ‘in-use’ condition 150, according to an embodiment of the present disclosure. As illustrated, the bluetooth powerpack for wireless LED string lights 100 may include a light assembly 110, an LED light strand 120, and a power pack 130 including a battery 140, and a housing 144. The power pack system 100 is in wireless communication with a mobile application hosted on a mobile device 10. The power pack 130 is connected to and configured to provide power to lights configured on the LED light strand 120. The LED light strand 120 is controlled via the mobile application. The power pack 130 provides a portable power source for the LED light strand 120. The housing houses 144 the battery 140. The present invention may be integrated in a children's costume to enhance a child's imagination and experience by providing illuminated garments 15.

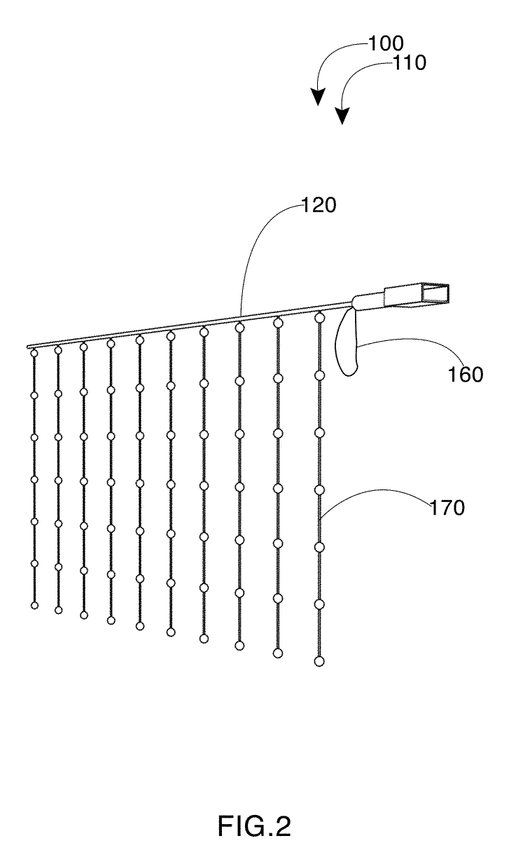

FIG. 2 shows a perspective view of the bluetooth powerpack for wireless LED string lights 100 of FIG. 1, according to an embodiment of the present disclosure. As above, the bluetooth powerpack for wireless LED string lights 100 may include the light assembly 110, the LED light strand 120, and the power pack 130 including the battery 140, and the housing 144 in functional combination to provide portable lighting. The light assembly 110 further comprises a connector. The connector connects the LED light strand 120 and the power pack 130 to provide power to the LED light strand 120. In a preferred embodiment, the connector may include a magnetic connector 20.

The LED light strand 120 is configured to be integrated into a garment 15 to provide illumination. The garment 15 may include children's costume garments, such as skirts, dresses, crowns, and bed canopies. The LED light strand 120 is configured to be integrated into any fabric. The LED light strand 120 further includes a braided cloth LED wire covering. The braided cloth LED wire covering is an extension 160 for stitching the LED light strand to the garment 15. Wires of the LED light strand 120 are bundled and glued together.

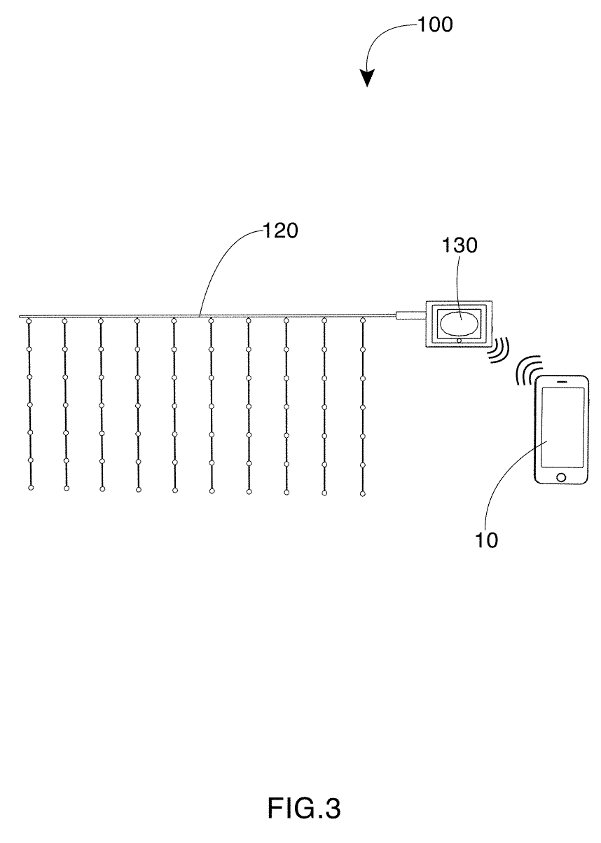

Referring now to FIG. 3 showing a perspective view of the bluetooth powerpack for wireless LED string lights 100 of FIG. 1, according to an embodiment of the present disclosure. As above, the bluetooth powerpack for wireless LED string lights 100 may include the light assembly 110, the LED light strand 120, and the power pack 130 for illuminating garments 15. The LED light strand 120 includes a horizontal section and a plurality of vertical light-strands 170 extending therefrom. The plurality of vertical light-strands 170 are equidistantly spaced from one another. In a preferred embodiment, the plurality of vertical light-strands 170 are spaced approximately 100 mm from one another. A length of each of the plurality of vertical light-strands 170 is approximately 300 mm. Six of the lights are configured on the LED light strand 120.

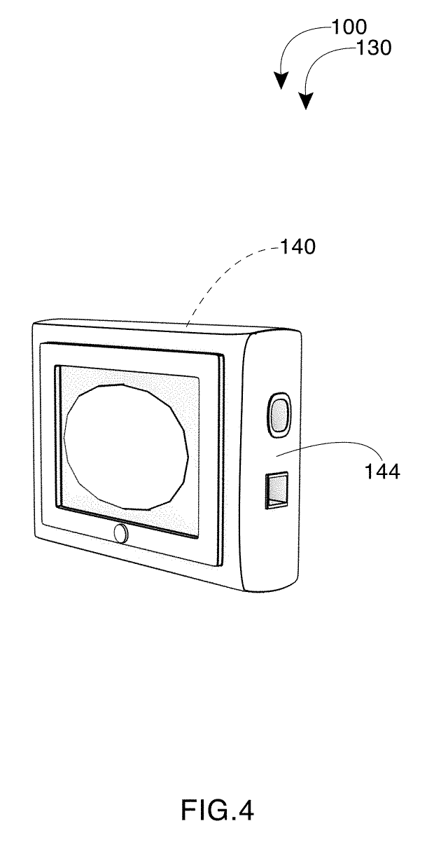

FIG. 4 shows a perspective view of the bluetooth powerpack for wireless LED string lights 100 of FIG. 1, according to an embodiment of the present disclosure. As above, the bluetooth powerpack for wireless LED string lights 100 may include the light assembly 110, the LED light strand 120, and the power pack 130 including the battery 140, and the housing 144. In certain embodiments, the battery 140 is rechargeable. The power pack 130 further comprises a USB outlet configured to receive a USB connector cable 20 for charging the battery 140. The light assembly 110 is controlled by a user on the mobile application hosted on the mobile device 10 such as a phone, tablet or other electronic device capable of supporting the mobile application.

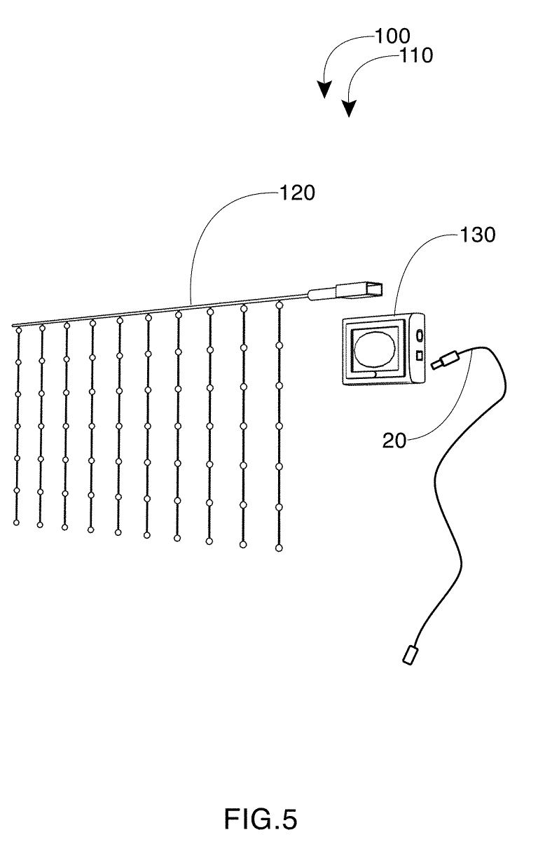

As shown in FIG. 5, the bluetooth powerpack for wireless LED string lights 100 may be arranged as a kit 105. In particular, the bluetooth powerpack for wireless LED string lights 100 may further include a set of instructions, at least one LED light strand 120, and a power pack 130. The instructions may detail functional relationships in relation to the structure of the bluetooth powerpack for wireless LED string lights 100 such that the bluetooth powerpack for wireless LED string lights 100 can be used, maintained, or the like, in a preferred manner.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A bluetooth powerpack for wireless LED string lights comprising:
a light assembly;
an LED light strand; and
a power pack including;
a battery; and
a housing;
wherein said LED light strand and power pack are in wireless communication with a mobile application hosted on a mobile device;
wherein said power pack is connected to and configured to provide power to lights configured on said LED light strand;
wherein said LED light strand is controlled via said mobile application;
wherein said power pack provides a portable power source for said LED light strand; and
wherein said housing houses said battery.

2. The bluetooth powerpack for wireless LED string lights of claim 1, wherein said light assembly further comprises a connector.

3. The bluetooth powerpack for wireless LED string lights of claim 2, wherein said connector connects said LED light strand and said power pack to provide power to said LED light strand.

4. The bluetooth powerpack for wireless LED string lights of claim 3, wherein said connector is a magnetic connector.

5. The bluetooth powerpack for wireless LED string lights of claim 1, wherein said LED light strand includes a horizontal section and a plurality of vertical light-strands extending therefrom.

6. The bluetooth powerpack for wireless LED string lights of claim 5, wherein said plurality of vertical light-strands are equidistantly spaced from one another.

7. The bluetooth powerpack for wireless LED string lights of claim 6, wherein said plurality of vertical light-strands are spaced approximately 100 mm from one another.

8. The bluetooth powerpack for wireless LED string lights of claim 7, wherein a length of each of said plurality of vertical light-strands is approximately 300 mm.

9. The bluetooth powerpack for wireless LED string lights of claim 1, wherein said LED light strand is configured to be integrated into a garment to provide illumination.

10. The bluetooth powerpack for wireless LED string lights of claim 9, wherein said garment is a costume.

11. The bluetooth powerpack for wireless LED string lights of claim 1, wherein said LED light strand is configured to be integrated into fabric.

12. The bluetooth powerpack for wireless LED string lights of claim 9, wherein said LED light strand further includes a braided cloth LED wire covering.

13. The bluetooth powerpack for wireless LED string lights of claim 12, wherein said braided cloth LED wire covering is an extension for stitching said LED light strand to said garment.

14. The bluetooth powerpack for wireless LED string lights of claim 1, wherein said battery is rechargeable.

15. The bluetooth powerpack for wireless LED string lights of claim 14, wherein said power pack further comprises a USB outlet configured to receive a USB connector cable for charging said battery.

16. The bluetooth powerpack for wireless LED string lights of claim 15, wherein said light assembly is controlled by a user on said mobile application hosted on said mobile device.

17. The bluetooth powerpack for wireless LED string lights of claim 1, wherein wires of said LED light strand are bundled and glued together.

18. The bluetooth powerpack for wireless LED string lights of claim 1, wherein six of said lights are configured on said LED light strand.

19. A bluetooth powerpack for wireless LED string lights, the bluetooth powerpack for wireless LED string lights comprising:
a light assembly;
an LED light strand; and
a power pack including;
a battery; and
a housing;
wherein said LED light strand and power pack are in wireless communication with a mobile application hosted on a mobile device;
wherein said power pack is connected to and configured to provide power to lights configured on said LED light strand;
wherein said LED light strand is controlled via said mobile application;
wherein said power pack provides a portable power source for said LED light strand;
wherein said housing houses said battery;
wherein said light assembly further comprises a connector;
wherein said connector connects said LED light strand and said power pack to provide power to said LED light strand;
wherein said connector is a magnetic connector;
wherein said LED light strand includes a horizontal section and a plurality of vertical light-strands extending therefrom;
wherein said plurality of vertical light-strands are equidistantly spaced from one another;
wherein said plurality of vertical light-strands are spaced approximately 100 mm from one another;
wherein a length of each of said plurality of vertical light-strands is approximately 300 mm;
wherein said LED light strand is configured to be integrated into a garment to provide illumination;
wherein said garment is a costume;
wherein said LED light strand is configured to be integrated into fabric;
wherein said LED light strand further includes a braided cloth LED wire covering;
wherein said braided cloth LED wire covering is an extension for stitching said LED light strand to said garment;
wherein said battery is rechargeable;
wherein said power pack further comprises a USB outlet configured to receive a USB connector cable for charging said battery;
wherein said light assembly is controlled by a user on said mobile application hosted on said mobile device;
wherein wires of said LED light strand are bundled and glued together; and
wherein six of said lights are configured on said LED light strand.

20. The bluetooth powerpack for wireless LED string lights of claim 19, further comprising a set of instructions; at least one LED light strand; and a power pack; and
wherein the bluetooth powerpack for wireless LED string lights is arranged as a kit for use with a garment.
